(19) United States
(12) Patent Application Publication
(10) Pub. No.: US 2013/0291444 A1
(43) Pub. Date: Nov. 7, 2013

(54) CMP SLURRY REGENERATION APPARATUS AND METHOD

(71) Applicant: Nihon Cabot Microelectronics KK, Tsu-shi (JP)

(72) Inventors: Takashi Matsuo, Osaka (JP); Yukinari Sato, Yokohama (JP); Takashi Mizuta, Atsugi-shi (JP)

(21) Appl. No.: 13/858,311

(22) Filed: Apr. 8, 2013

(30) Foreign Application Priority Data
Apr. 12, 2012 (JP) 2012-090942

(51) Int. Cl. C09G 1/02

(52) U.S. Cl. CPC C09G 1/02
USPC 51/308; 210/252; 210/201; 51/309

(57) ABSTRACT

The CMP slurry regeneration apparatus 200 for regenerating the CMP slurry used for a CMP process patterning metal conductive elements on a semiconductor circuit comprises a gravity separator 205 for precipitating solids in a diluted waste slurry used in the CMP process by gravity sedimentation; a concentrated slurry container 207 for reserving the solid through the gravity sedimentation in the gravity separator 205 as concentrated slurry 206; a solid-liquid separator 209 for catching components contained in the waste slurry as rinsed components through rinsing the waste slurry by remaining hydroxide corresponding to small amount metal ion while removing soluble and solid components formed by the CMP process; and a regenerated slurry container 211 for regenerating the small amount metal ion from the rinsed components.

### TECHNICAL FIELD

The present invention relates to a slurry regeneration technology used for polishing a semiconductor substrate, and more particularly relates to an apparatus and method for regenerating the slurry for chemical mechanical polishing for leveling the semiconductor substrate after deposition of metal in a via plug.

### BACKGROUND ART

Recently, semiconductor devices such as a central processing unit (CPU) and a semiconductor memory use an integrated circuit structure which is highly integrated with circuit layers multiply layered on one chip and each of layers is interconnected by a conductive element referred as a contact hole or via hole. When forming the semiconductor circuit with multiply layered structure, so called damascene process may be used to form conductive lines on the semiconductor layer. The damascene process is the process in which the conductive metal such as Cu, Al etc. is filled in recesses or holes formed in an oxide layer by a CVD method, then a semiconductor wafer is polished by the CMP slurry using the oxide layer as a polish stopper so as to remove excess conductive metal on the layer so as to pattern the conductive lines. The above described CMP process uses the CMP slurry which is the composition including metal oxides such as silica, alumina, ceria (cerium (IV) oxide), zirconia, and/or titania.

In the CMP process, for the planarization of the surface including conductive metal deposited in the conductive recess, via holes, or plugs, the CMP slurry is supplied between the wafer and a pad and then the pad is rotated on the wafer to remove objective materials mechanically from the chemically processed surface. Then, in the CMP process, when the mechanical polishing effect is too high, the problem of scratching the substrate surface tends to occur; in turn, when the chemical erosion effect becomes too high, the isotropic etching becomes superior process, thereby causing adverse effect such as dishing such that many and various properties are required to the CMP slurry.

More recently, since high integration and more fine ruling requirements become a trend for the semiconductor circuits and the electric field strength applied between the circuit devices tends to become high, tungsten (W) with high refractive point may be used as a blanket material in the contact hole or the via hole for the purpose of forming a diffusion barrier for the conductive metals in order for avoiding conduction defects due to diffusion of the conductive materials deposited in the contact holes and/or via holes. The blanket including tungsten may be removed from the substrate surface by RIE or CMP for subsequent process for formation of circuit elements after the deposition thereof through CVD etc.

Since RIE tends to cause defects by making seams and/or voids through the removal of W deposited on lateral regions of the hole, a CMP process may be preferably used in order to selectively remove tungsten (W) exposed on the surface. Furthermore, contradictory to the CMP process for oxides, tungsten has high refractive point as well as high hardness and then the CMP slurry used for the tungsten CMP must have high selectivity to tungsten for avoiding the adverse effect such as scratch and dishing.

Various slurry compositions used for tungsten CMP are known so far and for example, U.S. Pat. No. 5,244,534 (patent literature 1) describes the CMP slurry for tungsten comprising hydroperoxide, aluminum oxide particles, and KOH or NH₄OH etc. In U.S. Pat. No. 5,540,810 (patent literature 2), the CMP slurry comprising KOH, hydroperoxide, aluminum oxides etc. is described as for the CMP slurry for tungsten. In addition, the CMP slurry for tungsten containing benzotriazole is described in Japanese Patent (Laid Open) No. 1108-83780 (patent literature 3). Furthermore, in U.S. Pat. No. 3,822,339 (patent literature 4), the CMP slurry for tungsten containing oxide particles and hydroperoxide is described and Japanese Patent (Laid Open) No. H10-58314 (patent literature 5) describes a chemical-mechanical polishing apparatus and method for supplying recycled CMP slurry to the CMP process.

As described above, the CMP slurry must satisfy various kinds of properties and is itself expensive such that it becomes one of reason for increasing costs of the production process in the semiconductor device. Then, it may largely reduce the cost of the semiconductor production process and may reduce environment loads in the point of view of effective recycle of rare metal elements polished out as well as metal oxides contained in the CMP slurry when the used CMP slurry is recovered to apply and reused to the CMP process.

However, it was reported by Kaufman et. al (J. Electrochem. Soc., Vol. 11, November, 1991, p. 3460-3464: non-patent literature 1 that the waste CMP slurry used in the tungsten CMP process contained compounds such as tungsten polished as well as tungsten oxides etc. Furthermore, it was reported by Raghunath et. al. (Proceedings of the First International Symposium on Chemical Mechanical Planarization, p. 1-7, (1997), “Mechanistic Aspects Of Chemical Mechanical Polishing of Tungsten Using Ferric Ion Based Alumina Slurries”, p. 1-p. 7(1997): non-patent literature 2) that the aluminum oxides slurry containing ferric iron salt accelerated the formation of insoluble ferro tungstate (FeWO₄) by the CMP process on the tungsten and FeWO₄ might be easily formed with respect to increase of pH.

As described above, since tungsten and tungsten-containing compounds have high hardness and could not be supplied to the CMP process, the waste slurry was directly disposed in most cases. However, tungsten is not rare as so-called rare-earth metals but may be categorized into rare metals having many usages and then the disposal of the tungsten CMP slurry may enhance the environmental disadvantages. In this consideration, the inventor has developed a regeneration method and apparatus of the CMP slurry waste (Japanese Patent No. 4,353,991: patent literature 6).

Although the technology described in patent literature 6 may regenerate the waste CMP slurry for tungsten process, it may be possible to regenerate the CMP waste slurry with more effectively if excess components yet available present in the waste CMP slurry are recovered while only needless tungsten containing components may be separated.

### PATENT LITERATURE

[Patent Literature 1] U.S. Pat. No. 5,244,534
[Patent Literature 2] U.S. Pat. No. 5,540,810
[Patent Literature 3] Japanese Patent (Laid Open) No. H08-83780
[Patent Literature 4] U.S. Pat. No. 3,822,339
[Patent Literature 5] Japanese Patent (Laid Open) No. H10-58314
[Patent Literature 6] Japanese Patent No. 4,353,991

### NON-PATENT LITERATURE

[Non-patent Literature 1] J. Electrochem. Soc., Vol. 11, November, 1991, p. 3460-3464
[Non-patent Literature 2] Proceedings of the First International Symposium on Chemical Mechanical Planarization, p. 1-7, (1997)
[Non-patent Literature 3] Inorganic Qualitative Analysis Experiment, faculty of Integrated Human Studies, Studies on Material Science Course Ed., Kyoto University, KYORITSU SHUPPAN CO., LTD., p. 93, (Nov. 25, 1994))

### SUMMARY OF THE INVENTION

The present invention has been made by considering problems the above conventional techniques and an object of the present invention is to provide a slurry regeneration apparatus which enables to regenerate the waste CMP slurry for tungsten process and a method for regenerating the waste CMP slurry for tungsten process by providing a technology for recovering tungsten from the waste CMP slurry for tungsten process.

### Means for Addressing Problem

The inventor has analyzed problems of the conventional techniques that, as described in the non-patent literature 2, the oxide compounds including both of tungsten and iron elements are formed in the waste slurry after the CMP process when the CMP slurry including Fe³⁺ ion as an oxidizer is applied to the CMP process of the tungsten plug. The inventor has reached the present invention, based on the above consideration, making it possible to effectively regenerate the CMP slurry and to reuse the regenerated CMP slurry.

According to the present invention, pH of the waste CMP slurry after the tungsten CMP with the CMP slurry containing Fe ion is adjusted to form poor soluble hydroxide gel of low concentration metal ion components yet remained in the CMP slurry. The poor soluble hydroxide gel precipitates freely and is concentrated under the natural gravity together with silica or alumina present in the waste CMP slurry. Hereafter the slurry obtained in the concentration process is referenced by the term “concentrated slurry”.

During this concentration step, the hydroxide gel precipitates together with other particles such as silica etc. so that the particle components are effectively recovered. Then, the concentrated slurry is subjected to a rinse process through a solid-liquid separation means such as a ceramics filter. In this rinse process, the tungsten fine particle, iron oxides, and tungsten-iron oxides such as ferro tungstate may be removed. After unnecessary components are removed in this rinse process, the concentrated slurry is subjected to recovering process of low concentration metal ion components by the second pH adjustment and is subsequently subjected to adjustment of solid concentration to prepare the regenerated CMP slurry.

By using the above processes, the tungsten containing compounds formed during the CMP process could be effectively rinsed out. In turn, the low concentration metal ion component present in the CMP slurry could be easily recovered only by the second pH adjustment from the metal hydroxide depending on a solubility product thereof as metal ion in the regenerated CMP slurry.

### Technical Advantage

According to the present invention, the waste CMP slurry, which was applied to the CMP process and then was considered that the life thereof has been ended, can be regenerated by effectively removing the useless components while conserving useful low concentration metal ion as the poor soluble hydroxide without adding the low concentration metal ion to recover the low concentration metal ion in the regenerated CMP slurry from the hydroxide. As the results, the regeneration of the CMP slurry can be effectively completed in low costs such that it may be possible to reduce the production costs of the semiconductor devices and to recover effectively the rare metal elements.

### BRIEF DESCRIPTION OF DRAWINGS

FIG. 1 shows a schematic process for a CMP process to which the present regenerated slurry is applied.

FIG. 2 shows a schematic illustration of a CMP regeneration apparatus for regenerating the present waste slurry.

FIG. 3 shows a process flowchart of the present CMP slurry regeneration method

FIG. 4 shows properties of the slurry compositions obtained from the steps S300 to S302 described in FIG. 3 by showing specific gravities (g/cm³), pHs, average particle sizes (micro-meters), W (tungsten) concentration (ppm) and Fe ion concentration (ppm).

FIG. 5 shows exemplary particle size distributions of fresh slurry and waste slurry.

FIG. 6 shows results of concentration measurements by the ICP-AES method for the tungsten components and Fe components in the filtered water using the ceramics filter having opening of 0.2 micrometers pass as the solid-liquid separation filter 210.

FIG. 7 shows a relation between pH and the Fe³⁺ concentration used when the pH adjustment of the step S306 of FIG. 2 is conducted.

FIG. 8 shows a graphical plot of the tungsten removal rate by the regenerated CMP slurry and pH of the regenerated CMP slurry against the concentration of Fe ion in the regenerated slurry.

FIG. 9 shows properties of the regenerated slurry according to the present invention.

FIG. 10 shows removal rates for tungsten, titanium, and TEOS (tetra ethoxy silane) films.

### EMBODIMENT FOR PRACTICING INVENTION

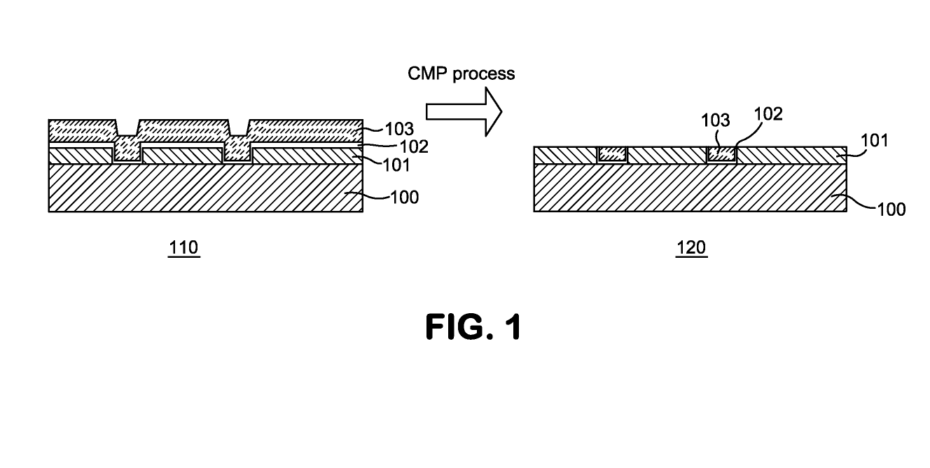

Hereafter, the present invention will be described using particular embodiment; however, the present invention should not be limited to the following embodiments. FIG. 1 shows the schematic CMP process to which the present regenerated slurry is applied. CMP (Chemical Mechanical Polishing) may be referred to so-called “Damascene” process and the wafer 110 to which the CMP process is applied and the wafer 110 comprises on the substrate the layer 101 which is deposited by an adequate deposition method, the blanket layer 102 of tungsten, and the conductive metal layer 103. Via holes, contact holes, or recesses for other conductive lines are patterned in the layer 101 using the processes such as photolithography and RIE (Reactive Ion Etching). The tungsten blanket layer 102 may be deposited in an adequate thickness thereon and then the recesses are filled with the conductive metal 103 such as Cu or Al.

The wafer 110 is then subjected to the planarization of the surface thereof in order to form multiple circuit structures. For the planarization, the CMP slurry, in which fine particles of silica, aluminum, or ceria are dispersed, may be used and the wafer 120 is obtained by the planarization of the surface of wafer 110 through the mechanical polishing with the fine particles as well as through the chemical erosion mechanism.

Since the wafer 120 is flattened the surface thereof by the CMP process, further process for forming the multiple circuit structures may be applied. The CMP process includes as shown as the wafer 120 applied to the CMP process of the conductive metal layer 103 and the blanket layer 102 comprising high refractory metal such as tungsten. Chemical and physical properties of the conductive metal layer 103 such as Cu and tungsten used as the blanket layer 102 are quite different, and then the CMP slurry compositions having different chemical and physical properties are used as the CMP slurry for Cu and the CMP slurry for tungsten.

The tungsten or the tungsten compounds polished by the CMP process may be present in the waste slurry as the dissolved state or as the dispersed state; here the term “waste slurry” refers to the CMP slurry after supplied to the CMP process. The waste slurry comprises unexpected particle components such that the adverse effects such as scratches, particle residue, and contamination will occur when the waste slurry might be reused directly to the process. Therefore, the waste slurry could not be reused if the unexpected components are removed. From the above reason, the CMP slurry was conventionally disposed as the waste slurry after the application to the CMP process due to lost of essential function thereof.

However, the waste slurry which is particularly applied to the CMP process for tungsten, as described above, still includes components such as the silica, alumina and small amounts of metal ion in compatible levels to the fresh CMP slurry as well as rare element tungsten and other components formed through the CMP process. Therefore, when the components formed through the CMP process are effectively removed for the regeneration, the regenerated slurry may be again supplied to the tungsten CMP process.

The present invention stands on the above technical consideration and the present invention regenerates the CMP slurry having sufficient properties again used to the tungsten CMP process by effectively removing the components originated from the CMP process from the waste slurry.

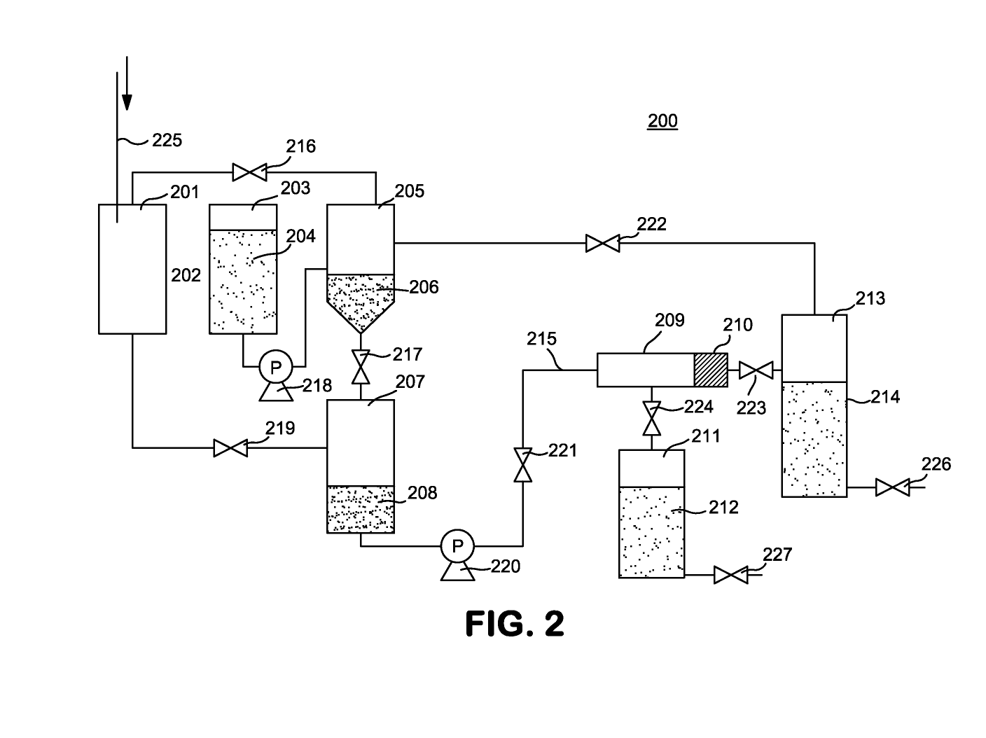

FIG. 2 shows the schematic illustration of the CMP slurry regeneration apparatus for regenerating the waste slurry according to the present invention. The CMP slurry regeneration apparatus of FIG. 2 removes hazardous components originated from the CMP process while preserving the small amounts metal ion components, silica and aluminum without applying high sheer stress and temperature and essentially without damaging the dispersibility of the dispersed component such as the silica or aluminum. Here, the small amounts metal ion component is a catalyst component used for tungsten polishing in the tungsten CMP and is a transition metal ion such as iron, copper, and noble metal elements which have the properties to form gel as hydroxide through the pH adjustment.

Now, the CMP slurry regeneration apparatus 200 of the present invention will be detailed. The CMP slurry regeneration apparatus 200 comprises the dilution waster container 201, the waste slurry container 203 and the gravity separator 205. The dilution water container 201 stores the dilution water 202 for the waste slurry and the pure water is supplied through the line 225. The waste slurry container 203 reserves the waste slurry 204 disposed from the CMP process. The waste slurry 204 may be supplied in in-line or off-line from the CMP process line.

The waste slurry 204 is transferred to the gravity separator 205 from the waste slurry container 203 by the pump 218. The waste slurry is subjected to solidity concentration by free sedimentation of solid components after the dilution with the dilution water 202 supplied through the valve 216. The dilution at this stage is applied so as to adjust pH of the waste slurry and pH of the dilution water supplied to the waste slurry container 203 may be adjusted to acid or alkaline beforehand. The dilution magnification may range between about 10 and about 200 depending on nature of the waste slurry.

By the dilution in the gravity separator 205 the small amount metal ion contained in the waste slurry precipitate as the hydroxide gel. In the particular embodiments, the small amount metal ion may be Fe³⁺ and as pH becomes increased (decrease of H⁺ ion concentration), Fe³⁺ precipitate as iron hydroxide Fe(OH)₃ according to the solubility product thereof (for Fe³⁺ ion, Ksp is 6×10⁻³⁸ and the hydroxide has extremely poor solubility). The precipitation appears as formation of the Fe(OH)₃ gel and the formed gel sediments together with other oxide particles during the gravity sedimentation such that available components including Fe³⁺ as small amount metal ion may be efficiently recovered. In this purpose, the dilution may preferable made such that pH of the waste slurry becomes to about 6 from about 2 in pH.

In the gravity separator 205, the concentrated slurry 206 precipitates at the bottom of the gravity separator 205 by natural sedimentation only by the gravity. Since large sheer stress could not applied to Fe(OH)₃ formed by the pH adjustment, Fe(OH)₃ precipitates as gel state without becoming sol as the concentrated slurry 206. After precipitation of the concentrated slurry 206, the concentrated slurry 206 is transferred to the concentrated slurry container 207 together with a part of upper water through the valve 207. The concentrated slurry 208 transferred to the concentrated slurry container 207 is supplied with rinsing water from the valve 219 and then is transferred to the solid-liquid separator 209 through the valve 221 by the pump 220. Form the upper part of the gravity separator 205, the line for disposing upper water extends to the waste container 213 through the valve 222 and the batch process for the gravity sedimentation may be effectively performed.

The solid-liquid separator 209 is equipped with the solid-liquid separating filter 210 to rinse the solid by passing dissolved components and finer particles than a nominal opening of the solid-liquid separating filter 210. The solid-liquid separating filter 210 may include a membrane filter, a ceramics filter, or a chelate resin filter etc. and the opening thereof may range between about 50 nm to 5 micrometers. The opening may be adequately selected depending on particular conditions of process rate such as recover rate or clogging up of the filter.

To the solid-liquid separator 209 the dilution water 202 is supplied from the dilution water container 201 continuously to perform rinsing. At the output side of the solid-liquid separating filter 210 equipped with the solid-liquid separator 209, the on-off valve 223 is disposed and the rinsed waste is discharged to the waste container 213 until the concentrations of the CMP process disposals become not more than preset thresholds (1 ppm for each cases) depending on results of periodic or continuous analysis of tungsten concentration and Fe ion concentration. When the tungsten concentration and Fe ion concentration become not more than the preset thresholds, the on-off valve 223 is driven to terminate the rinse waste and at the same time the valve 224 is opened to transfer the reserved rinsed components in the solid-liquid separator 209 to the regenerated slurry container 211.

In the regenerated slurry container 211, the dilution and the pH adjustment of the recovered rinsed components is performed. The pH adjustment may be set to an adequate value depending on the solubility of hydroxide such that the small amount metal ion may be recovered from the hydroxide gel. When the Fe³⁺←→Fe(OH)₃ case, the pH range from 2 to 2.5, the recovery of Fe³⁺ ion present in the rinsed components may be possible. When the pH adjustment is incomplete, remained Fe(OH)₃ is oxidized to Fe₂O₃ by subsequent processes to cause brown color in the regenerated slurry 212, and then the pH value may be set to the sufficient range.

After the rinsed components are applied to component adjustments in the regenerated slurry container 211, the regenerated slurry 212 is recovered through the valve 227. The waste may be recovered for in order to recover rare metal components in separated processes.

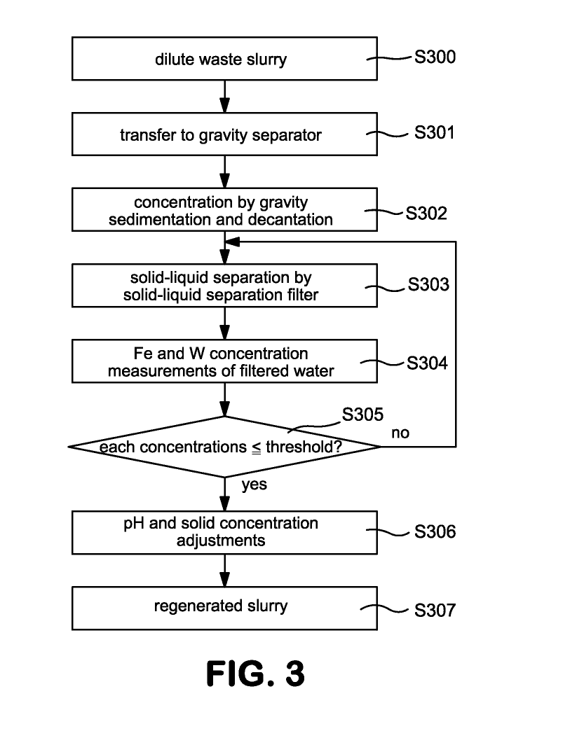

The CMP slurry regeneration process of the present embodiment using the CMP slurry regeneration apparatus shown in FIG. 2 will be detailed by the process flowchart depicted in FIG. 3. Prior to start detailed description of the process flowchart of FIG. 3, The chemistry of the tungsten by the CMP process will be reviewed. The CMP slurry for tungsten oxidizes tungsten under the acidic environment in the range of pH≧2 according to the following chemical formula (1):

Chemical Formula 1

6Fe³⁺+6e→6Fe²⁺

W+3H₂O→WO₃+6H⁺+6e

Fe²⁺+WO₂+H₂O→FeWO₄+2H⁺

Overall reaction

6Fe²⁺+W+4H₂O→5Fe²⁺+8H⁺+FeWO₄(s) (1)

As described above, thus in the CMP process of tungsten, the CMP process proceeds by oxidizing tungsten where Fe³⁺ is reduced to Fe²⁺ and then Fe²⁺ oxidizes tungsten oxide to ion (II) tungstate (solid) and following mechanical polishing.

From the above mechanism, the waste CMP slurry may include oxide particles such as silica and alumina, small amount metal ion, tungsten particles, ferro tangstate and water as solvent and the waste CMP slurry may in most cases be acid.

According to the above waste CMP slurry composition, if only tungsten containing components are removed from the waste CMP slurry, it is deemed that the waste CMP slurry could practically be recovered. In the recovery, it is important not to remove substantial portion of the small amount of metal ion which are still included in the waste CMP slurry.

Thus the present invention considers that transition metal ion almost always form poor water soluble oxides and the present invention uses the essential feature that the small amount metal ion is subjected to solid-water separation after converting the small amount metal ion to the state being separated by the solid-liquid separation by solidifying the small amount metal ion as the hydroxide gel through the pH adjustment. Then the present embodiment adjusts the pH of the waste CMP slurry containing the small amount metal ion to form the gel of metal hydroxides corresponding to the small amount metal ion and then the small amount metal ion may be separated by quasi-statistical solid-liquid separation in which the formed gel could not to change the sol state.

Here again referring to FIG. 2, the CMP slurry regeneration method will be described. The waste slurry recovered in the step S300 is transferred to the waste slurry container 203, and then the dilution water is supplied thereto from the dilution water container 201 to adjust pH within the sufficient range for converting the small amount metal ion into hydroxide gel. The pH adjustment in this step may be made by only dilution or may be made by addition of alkaline solution to which an agent such as sodium hydroxide is added to the dilution water to introduce a hydroxide group intentionally.

Here, in the particular embodiment that Fe³⁺ ion is included as the small amount metal ion, Fe²⁺ ion may be formed in the CMP process as described in the formula (1); however, the most of Fe element may present as the ferric ion (III) condition in the waste CMP slurry due to peroxide such as H₂O₂ or oxygen in air. When the small amount metal ion is assumed to Fe³⁺ in the particular embodiment, the Fe³⁺ concentration at the given solution pH may be calculated by following formula (2) using the solubility product (:Inorganic Qualitative Analysis Experiment, faculty of Integrated Human Studies, Studies on Material Science Course Ed. Kyoto University, KYORITSU SHUPPAN CO., LTD., p. 93, (Nov. 25, 1994)):

Formula 1

log [Fe³⁺]=4.8−3pH (1)

Then the Fe(OH)₃ forms the hydroxide gel due to the quasi-static dilution the step S302 and the Fe(OH)₃ is precipitated as the solid together with particle component such as silica present in the waste slurry. Then the precipitated solid are transferred to the concentrated slurry container 207 to subject so-called decantation procedure for further concentration. This concentration is added in order to decrease the process object volume as well as to prevent the hydroxide gel from turning to sol. Then, the rinsing process is applied in the step S305 by the solid-liquid separation filter 210 to remove the tungsten components and other unnecessary components from the concentrated slurry.

In the step S304, the W concentration of the Fe concentration in the filtered water are measured and if the concentrations are not less than the threshold (no), the steps S 303 and 304 are repeated until the determination in the step S305 indicates that the concentrations are not more than the threshold. When each of the concentrations becomes not more than the threshold (yes), the concentrated slurry is transferred to the regenerated slurry container 211 in the step S306 and is diluted by the dilution water to adjust the concentration thereof from the concentrated state. In this step, the Fe(OH)₃ of the particular embodiment contained in the concentrated slurry recovers Fe³⁺ ion in the water as pH (increase of H⁺ concentration) decreases according to the formula 1 and further then the regenerated slurry is obtained in the Step S307.

The pH adjustment in the step S306 may be conducted by using proper inorganic acids such as hydrogen chloride, nitric acid, and/or sulfuric acid and the pH adjustment may be preferably made by using hydrogen chloride because the hydrogen chloride acts as a stabilizer of H₂O₂ which is added as the oxidizer of tungsten in the CMP process.

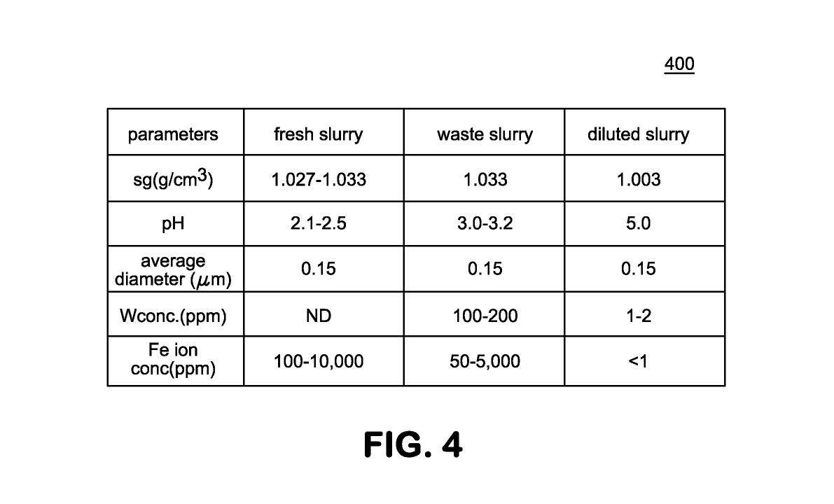

FIG. 4 shows the properties of the slurry compositions obtained from the steps S300 to S302 described in FIG. 3 by showing specific gravities (g/cm³), pHs, average particle sizes (micro-meters), W (tungsten) concentration (ppm) and Fe ion concentration (ppm). In FIG. 4, the data of the reference commercial tungsten CMP slurry available from Cabot Microelectronics Corporation, Aurora, Ill. USA), W-2000 are shown. Here, the average particle size was measured by Model 780 AccuSizer (Particle Sizing Systems Inc., Santa Barbara, Calif., USA) was used and represents a volume averaged particle size and the W concentration and Fe ion concentration were measured by the atomic emission method according to JIS M 8852 ICP-AES (JIS R 5202 ICP-AES).

As shown in FIG. 4, pH of the waste slurry ranged from 3.0 to 3.2 and in the diluted slurry diluted by the pH adjustment, the hydrogen ion concentration decreases as low as pH=5.0. In addition as shown as the mean particle size, it is shown that any particle aggregation due to the dilution process may not occur. Further to the above, the W and Fe ion concentrations are ND (Non-detected) and 100-10,000 ppm, respectively for the fresh slurry; however, those in the waste slurry are 50-5,000 ppm and 6 ppm, respectively. For the diluted slurry, the W concentration and Fe ion concentrations are 1-2 ppm and less than 1 ppm, respectively according to the dilution. The Fe ion concentration decreases significantly with respect to the dilution magnification because the part being excess to dissolution due to the dilution precipitates as Fe(OH)₃ according to the solubility product. The concentration shown in FIG. 4 may due to some contamination of Fe elements.

Fe²⁺ ion may be present in the waste slurry as shown in the above chemical formula (1). The presence of Fe²⁺ ion provides the possibility for unexpected formation of oxy-hydroxyl iron during the pH adjustment as described in Japanese Patent (Laid Open) No. 2004-26621. The present invention achieves the separation of Fe²⁺ ion using solubility of the hydroxide thereof. Now, the removal of Fe²⁺ ion will be discussed. According to the non-patent literature 3, the concentration of water soluble Fe³⁺ ion may be provided by the following formula (2):

Formula 2

log [Fe²⁺]=13.3−2pH (2)

According to the formula (2), when the pH adjustment up to pH=5 as described below, the ion concentration of Fe²⁺ being present in the water may be log [Fe^{2+]}=3.3, that means Fe²⁺ may be present in the water up to about 1000 mol/litter at pH=5, and hence Fe²⁺ ion may essentially be dissolved in the water so that Fe²⁺ ion could be almost perfectly removed from the waste slurry by the gravity sedimentation process and the solid-liquid separation process. The Fe ion concentration measurement in the step S304 does not distinguish Fe³⁺ ion and Fe²⁺ ion, and then the concentration of Fe ion components may substantially come from contamination Fe²⁺ or the Fe element component by ferro tangustate. This means that the present invention substantially adopts as the termination criteria of the rinsing the removal of iron (II) ion, i.e, ferrous ion from the water. Even though when the Fe²⁺ ion in the contamination level is present, such contamination level Fe²⁺ may be oxidized to Fe³⁺ ion in the following pH adjustment such that the contamination Fe²⁺ may be recovered as Fe³⁺ in the regenerated slurry. As described above, the regenerated slurry may be substantially recovered in the Fe²⁺ free condition while recovering Fe components as the small amount metal component.

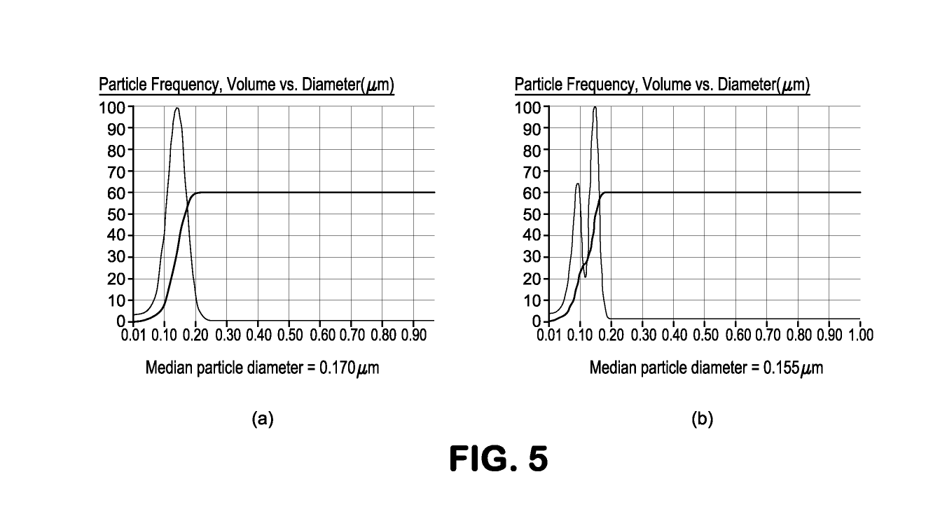

FIG. 5 shows exemplary particle size distributions of the fresh slurry and the waste slurry. FIG. 5(a) shows the particle size distribution (volume averaged particle diameter) of the fresh slurry and FIG. 5(b) shows the particle size distribution of the waste slurry. The fresh has the single peak distribution of the Median size=0.17 micrometers and it was found that the waste slurry had the double peaked distribution with the Median particle size=0.155 micrometers. The finer side peak does not appear in the fresh slurry shown in FIG. 5(a) and is interpreted as the insoluble components such that the finer side peak may be interpreted as the presence of the tungsten fine particles and ferro tangustate fine particles.

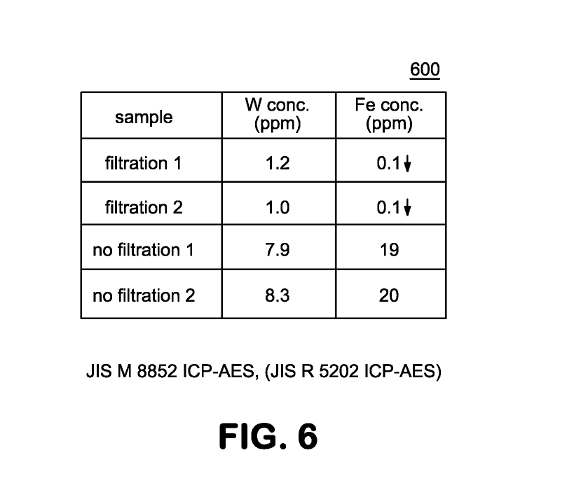

Based on the results shown in FIG. 5, the separation of tungsten and iron maybe attained. FIG. 6 shows the results of concentration measurements by the ICP-AES method for the tungsten components and Fe components in the filtered water during the concentration process in the step S302 using the ceramics filter having opening of 0.2 micrometers pass as the solid-liquid separation filter 210. As shown in FIG. 6, when the ceramics filter having the nominal opening=0.2 micrometers is used (filtration 1 and filtration 2), it was found that the W and Fe concentrations in the filtered water becomes significantly decreased when compared to the comparable experiments (non-filtered 1 and non-filtered 2 for concentrated slurry). As described above, the components to be removed could be filtered off to the level that does not cause practical problems by rinsing the solidity in the waste slurry with adjusting the opening of the solid-liquid separation filter.

As the conclusion, the W and Fe components being present in the slurry and being filtered off may be particles with the sizes which may be separated with the ceramics filter of 0.2 micrometer pass. Then it may be speculated that, while the present invention should not be limited by particular theory, the tungsten components removed from the waste slurry may be present together with the Fe element as FeWO₄ according the above reaction formula (1) and the removal ratio of W and Fe in FIG. 6.

As described above, by rinsing the concentrated slurry repeatedly using the filter having for example 1.0 micrometer not less than 0.2 micrometer due to the process rate, it may possible to remove the tungsten and the tungsten containing components from the concentrated slurry. On the other hand, Fe(OH)3 gel are still remained in the concentrated slurry together with the oxide particles such that the small amount metal ion could be recovered in the water phase by the pH adjustment.

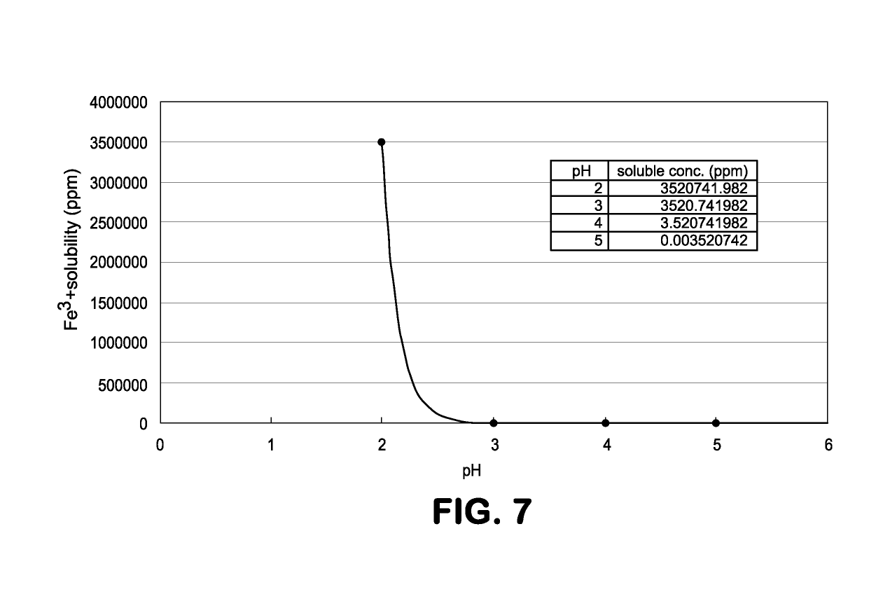

FIG. 7 shows the relation between pH and the Fe³⁺ concentration used when the pH adjustment of the step S306 of FIG. 2 is conducted. Here, in FIG. 7 the maximum allowed concentrations (ppm) at each of the pH value are marked as reference. As shown in the plots of FIG. 7 when the hydrogen ion concentration is adjusted from pH=5 to pH=2.5, the Fe(OH)₃ present as the gel in the concentrated slurry releases Fe³⁺ due to the solubility equilibrium to recover the small amount metal ion in the solution.

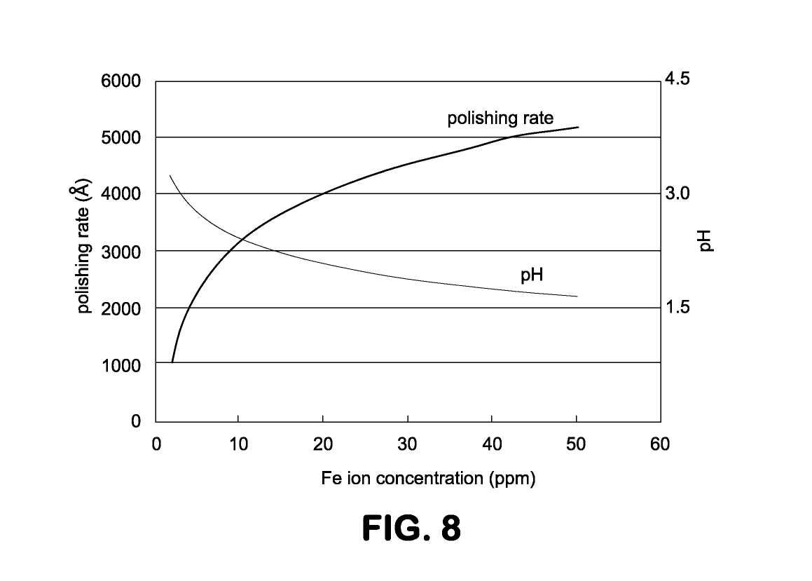

FIG. 8 shows the graphical plot of the tungsten removal rate by the regenerated CMP slurry and pH of the regenerated CMP slurry against the concentration of Fe ion in the regenerated slurry. The Fe ion concentration increases as pH becomes low, i.e., H⁺ ion concentration becomes high) and the removal rate increases accordingly. In the step S 306 of FIG. 2, as shown in FIG. 8, the pH value may preferable be adjusted to the range between 2 and 2.5.

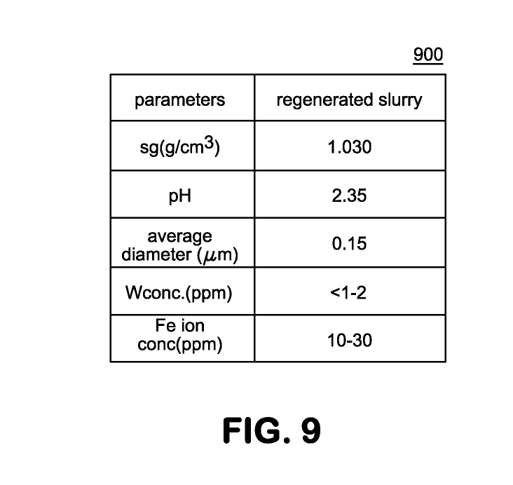

FIG. 9 shows the properties of he regenerated slurry according to the present invention. The present invention may recover the CMP slurry in the properties such as specific gravities, pHs, average particle sizes, tungsten concentrations and Fe³⁺ ion concentration when compared to the fresh slurry. Here, the Fe³⁺ ion concentration may further be increased by lowering pH during the pH adjustment process in the step S306. When the present regeneration slurry is used as a dilution agent for the fresh slurry, the pH value may be adjusted depending on a mixing ratio to the fresh slurry.

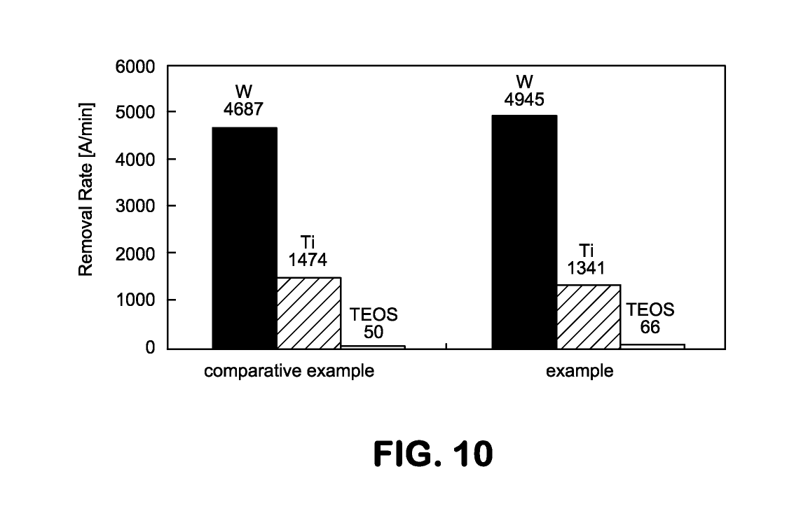

FIG. 10 shows removal rates for tungsten, titanium, and TEOS (tetra ethoxy silane) films deposited on the wafer independently by using the present regenerated slurry and a commercially available CMP polishing apparatus and the results are shown for examples (present regenerated slurry) and for comparative example (commercially available CMP slurry for tungsten, Cabot Microelectronics Corporation. W-2000). The polishing condition was set as load weight=4.2 psi, rotation speed=100 rpm, and slurry flow rate=150 cc/min. As shown in FIG. 10, the removal rate to be about 5000 angstroms for tungsten (W) both for the example and the comparative example; for Ti film slightly inferior result was observed in the example; and for TEOS film the removal rates were less than 100 angstroms both for the example and the comparative example.

The following table 1 lists the numeral results for each trial. FIG. 10 and the following table 1 show that the regenerated slurry of the present invention may provide compatible performances with the commercially available tungsten CMP slurry adopted as the comparative example.

TABLE 1

| | Species A | | Species B | | Species C | |
|---|---|---|---|---|---|---|
| | (W) | | (Ti) | | (TEOS) | |
| | R.R. | | R.R. | | R.R. | Ratio |
| | [A/min] | Ratio [%] | [A/min] | Ratio [%] | [A/min] | [%] |
| Reference | 4687 | 100.0 | 1474 | 100.0 | 50 | 100.0 |
| Sample | 4945 | 105.5 | 1341 | 91.0 | 66 | 130.8 |

The present regenerated slurry, depending on CMP process properties, costs, or product yields, may be optionally used by mixing with the commercial tungsten slurry described as the comparative example or may be applied to the tungsten CMP process by only using the present regenerated slurry.

As described hereinabove, according to the present invention, it may be possible that unnecessary components may be removed while remaining essential components from the waste slurry used to tungsten CMP, which has been considered conventionally to be exhausted and hard to be recovered and then has been disposed after usage. Then the present invention may provide the CMP slurry regeneration apparatus and the CMP slurry regeneration method by reducing the production costs of semiconductor devices with multiple layer structure while recovering efficiently rare metals such as tungsten.

### INDUSTRIAL APPLICABILITY

According to the present invention, the present invention may provide the CMP slurry regeneration apparatus and the CMP slurry regeneration method for regenerating the slurry which is reused to the tungsten CMP process again may be provided such that the production costs of semiconductor devices fabricated as highly integrated and multiple layer structure will be significantly reduced and the recover of the rare metals may become more efficient.

### DESCRIPTION OF SIGNS

100—substrate
101—layer
102—blanket layer
103—conductive metal layer
110—wafer
120—wafer
200—CMP slurry regeneration apparatus
201—dilution water container
202—dilution water
203—waste slurry container
204—waste slurry
205—gravity separator
206—concentrated slurry
207—concentrated slurry container
208—concentrated slurry
209—solid-liquid separator
210—solid-liquid separation filter
211—regenerated slurry container
212—regenerated slurry
213—waste container

1. A CMP slurry regeneration apparatus for regenerating the CMP slurry used for a CMP process patterning metal conductive elements on a semiconductor circuit, the CMP slurry regeneration apparatus comprising:
a. a gravity separator for precipitating solids in a diluted waste slurry used in the CMP process by gravity sedimentation;
b. a concentrated slurry container for reserving the solid through the gravity sedimentation in the gravity separator as concentrated slurry;
c. a solid-liquid separator for catching components contained in the waste slurry as rinsed components through rinsing the waste slurry by remaining hydroxide corresponding to small amount metal ion while removing soluble and solid components formed by the CMP process; and
d. a regenerated slurry container for regenerating the small amount metal ion from the rinsed components.

2. The apparatus of claim 1, wherein the metal conductive elements comprise tungsten.

3. The apparatus of claim 1, wherein the solids comprise the hydroxide of the small amount metal ion.

4. The apparatus of claim 1, wherein the soluble and solid components comprise a tungsten element and an iron element.

5. The apparatus of claim 1, wherein the rinsed components comprise silica and metal hydroxide gel.

6. The apparatus of claim 1, wherein the small amount metal ion is regenerated by a pH adjustment of the metal hydroxide gel.

7. The apparatus of claim 1, wherein the small amount metal ion is Fe³⁺ and the regeneration of Fe³⁺ ion is performed by pH adjustment using hydrogen chloride.

8. A method or regenerating the CMP slurry used for a CMP process patterning metal conductive elements on a semiconductor circuit, the CMP slurry regeneration method comprising the steps of:
a. precipitating solids by gravity sedimentation after diluting waste slurry used in the CMP process;
b. recovering gravity sedimentation solids as concentrated slurry;
c. catching components contained in the waste slurry as rinsed components through rinsing the waste slurry by remaining hydroxide corresponding to small amount metal ion while removing soluble and solid components formed by the CMP process; and
d. regenerating the small amount metal ion from the rinsed components.

9. The method of claim 8, wherein the metal conductive elements comprise tungsten and the solids comprise the hydroxide of the small amount metal ion.

10. The method of claim 8, wherein the soluble and solid components comprise a tungsten element and an iron element and the rinsed components comprise silica and metal hydroxide gel.

11. The method of claim 8, wherein the small amount metal ion is regenerated by a pH adjustment of the metal hydroxide gel and the small amount metal ion is Fe³⁺ and the regeneration of Fe³⁺ ion is performed by pH adjustment using hydrogen chloride.
